(19) United States
(12) Patent Application Publication
(10) Pub. No.: US 2026/0211588 A1
(43) Pub. Date: Jul. 23, 2026

(54) NON-TRANSITORY COMPUTER READABLE STORAGE MEDIUM

(71) Applicant: BROTHER KOGYO KABUSHIKI KAISHA, Nagoya (JP)

(72) Inventor: Masatoshi Kadota, Takahama (JP)

(21) Appl. No.: 19/570,587

(22) Filed: Mar. 18, 2026

Related U.S. Application Data
(63) Continuation of application No. PCT/JP2025/004104, filed on Feb. 7, 2025.

(30) Foreign Application Priority Data
Mar. 21, 2024 (JP) 2024-045013

(51) Int. Cl. G06F 3/12; G06F 8/61

(52) U.S. Cl. CPC G06F 3/1205; G06F 3/1237; G06F 8/61

(57) ABSTRACT

A non-transitory computer readable storage medium storing a virtual printer management program executable by a processor of an information processing device. The information processing device is configured to be connected to a plurality of printing devices. The information processing device includes OS standard printing software that is installed as standard in an operating system and is configured to execute driverless printing that performs printing without using a driver provided by a printer vendor, and a plurality of information processing programs registered in the OS standard printing software as virtual printers corresponding to the plurality of printing devices.

### REFERENCE TO RELATED APPLICATIONS

This is a continuation application of International Application No. PCT/JP25/004104 filed on Feb. 7, 2025, which claims priority from Japanese Patent Application No. 2024-045013 filed on Mar. 21, 2024. The entire contents of the aforementioned applications are incorporated herein by reference.

### BACKGROUND ART

An application program that operates as if it were a single virtual printer based on a logical OR of capability information of a plurality of printing devices is known. In the program of the related art, in a case where a print setting unique to a printing device used for printing is received and a print instruction is received, one printing device optimum for the received print setting is selected from the plurality of printing devices, and print data is transmitted to the printing device.

In the related art described above, a user can make a print setting unique to a printing device with respect to a virtual printer, without being aware of which printing device of the plurality of printing devices is to execute printing. However, the association between the virtual printer and the printing device is not clear to the user, and printing may be executed by a printing device different from a printing device desired by the user.

An object of the present invention is to provide a management program capable of executing a unique print setting by a virtual printer corresponding to a desired printing device, without processing by the user corresponding to the virtual printer.

### SUMMARY

A non-transitory computer readable storage medium storing a virtual printer management program executable by a processor of an information processing device, the information processing device being configured to be connected to a plurality of printing devices,
the information processing device including:
   OS standard printing software that is installed as standard in an operating system and is configured to execute driverless printing that performs printing without using a driver provided by a printer vendor; and
   a plurality of information processing programs registered in the OS standard printing software as virtual printers corresponding to the plurality of printing devices,
in which the virtual printer management program is configured to, when executed by the processor, cause a controller of the information processing device to execute:
a selection screen display process of outputting selection screen display data for causing a display unit of the information processing device to display a selection screen that allows a selection of the plurality of printing devices corresponding to the plurality of information processing programs registered in the OS standard printing software as the virtual printers;
a selection reception process of receiving, on the displayed selection screen, a selection operation of selecting one printing device among the plurality of printing devices; and
a setting screen activation process of executing a process of causing one information processing program corresponding to the one printing device received in the selection reception process, among the plurality of information processing programs registered in the OS standard printing software as the virtual printers corresponding to the plurality of printing devices, to display a print setting screen of the one printing device received in the selection reception process on the display unit of the information processing device.

### BRIEF DESCRIPTION OF DRAWINGS

FIG. 1 is a block diagram illustrating an example of a system configuration of a printing system and a functional configuration of a terminal device according to an embodiment of the present invention.

FIG. 2 is a block diagram illustrating a specific example of the printing system when a plurality of printer applications are installed in the terminal device.

FIG. 3A is a diagram illustrating an example of a dialog box displayed on a display unit of the terminal device by a launcher when a first printer application is installed in the terminal device.

FIG. 3B is a diagram illustrating an example of a dialog box displayed on the display unit of the terminal device by the launcher when the first printer application is installed in the terminal device.

FIG. 3C is a diagram illustrating an example of a dialog box displayed on the display unit of the terminal device by the launcher when the first printer application is installed in the terminal device.

FIG. 4A is a diagram illustrating an example of a dialog box displayed on the display unit of the terminal device by the launcher when a second printer application is installed in the terminal device.

FIG. 4B is a diagram illustrating an example of a dialog box displayed on the display unit of the terminal device by the launcher when the second printer application is installed in the terminal device.

FIG. 4C is a diagram illustrating an example of a dialog box displayed on the display unit of the terminal device by the launcher when the second printer application is installed in the terminal device.

FIG. 5A is a diagram illustrating an example of a dialog box displayed on the display unit of the terminal device by the launcher when a first printer of a printer group 1 is registered in the first printer application.

FIG. 5B is a diagram illustrating an example of a dialog box displayed on the display unit of the terminal device by the launcher when the first printer of the printer group 1 is registered in the first printer application.

FIG. 5C is a diagram illustrating an example of a dialog box displayed on the display unit of the terminal device by the launcher when the first printer of the printer group 1 is registered in the first printer application.

FIG. 5D is a diagram illustrating an example of a dialog box displayed on the display unit of the terminal device by the launcher when the first printer of the printer group 1 is registered in the first printer application.

FIG. 6A is a diagram illustrating an example of a dialog box displayed on the display unit of the terminal device by the launcher when a second printer of a printer group 2 is registered in the second printer application.

FIG. 6B is a diagram illustrating an example of a dialog box displayed on the display unit of the terminal device by the launcher when the second printer of the printer group 2 is registered in the second printer application.

FIG. 6C is a diagram illustrating an example of a dialog box displayed on the display unit of the terminal device by the launcher when the second printer of the printer group 2 is registered in the second printer application.

FIG. 6D is a diagram illustrating an example of a dialog box displayed on the display unit of the terminal device by the launcher when the second printer of the printer group 2 is registered in the second printer application.

FIG. 7A is a diagram illustrating an example of a dialog box displayed on the display unit of the terminal device by the launcher when a third printer of the printer group 2 is registered in the second printer application.

FIG. 7B is a diagram illustrating an example of a dialog box displayed on the display unit of the terminal device by the launcher when the third printer of the printer group 2 is registered in the second printer application.

FIG. 7C is a diagram illustrating an example of a dialog box displayed on the display unit of the terminal device by the launcher when the third printer of the printer group 2 is registered in the second printer application.

FIG. 7D is a diagram illustrating an example of a dialog box displayed on the display unit of the terminal device by the launcher when the third printer of the printer group 2 is registered in the second printer application.

FIG. 8A is a diagram illustrating an example of a dialog box displayed on the display unit of the terminal device by the launcher when a user selects a desired printer and displays a print setting screen.

FIG. 8B is a diagram illustrating an example of a dialog box displayed on the display unit of the terminal device by the launcher when the user selects the desired printer and displays the print setting screen.

FIG. 9 is a flowchart illustrating an example of a control procedure executed when the launcher is activated.

FIG. 10 is a flowchart illustrating an example of a control procedure executed by the launcher when step S100, which is a click event of an install button, occurs.

FIG. 11 is a flowchart illustrating an example of a control procedure executed by the launcher when step S200, which is a button selection event of a printer application, occurs.

FIG. 12 is a flowchart illustrating an example of a control procedure executed by the launcher when step S300, which is a button selection event of a printer application, occurs.

FIG. 13 is a flowchart illustrating an example of a control procedure executed by the launcher in a process for a printer application to be processed in step S310.

FIG. 14 is a flowchart illustrating an example of a control procedure executed by the launcher when step S400, which is a click event of a printer button, occurs.

FIG. 15 is a block diagram illustrating an example of a hardware configuration of the terminal device and a printer.

### DESCRIPTION

### Embodiment

An embodiment of the present disclosure will be described with reference to the drawings.

### Outline of Printing System

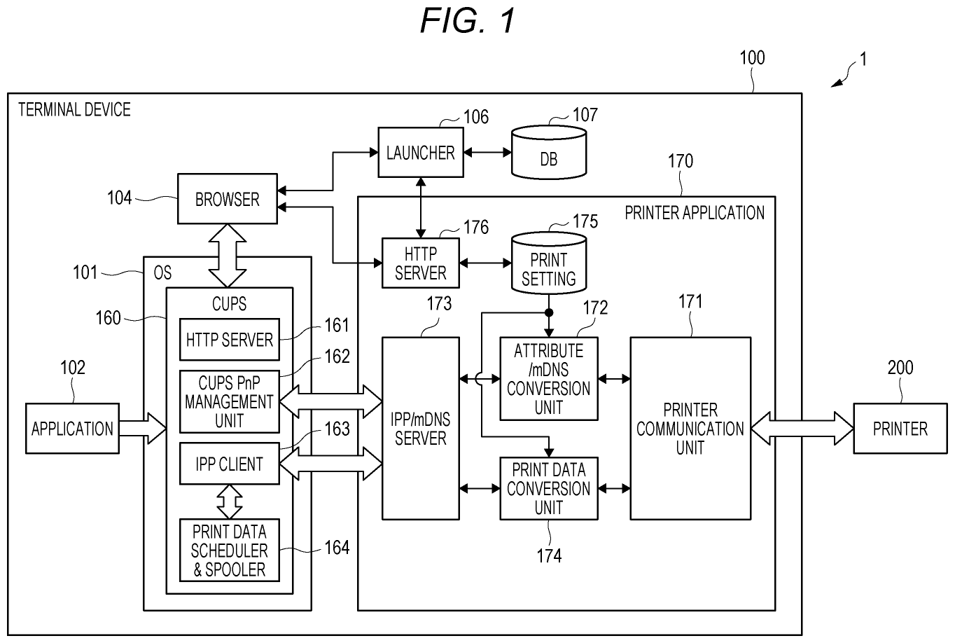

FIG. 1 illustrates an example of a system configuration of a printing system 1 according to the present embodiment. In FIG. 1, a printing system 1 includes a terminal device 100 and a printer 200. The terminal device 100 and the printer 200 are communicably connected via, for example, the Internet, a wired LAN, a wireless LAN, or the like. The terminal device 100 is an example of an information processing device, and the printer 200 is an example of a printing device.

### Functional Configuration of Terminal Device

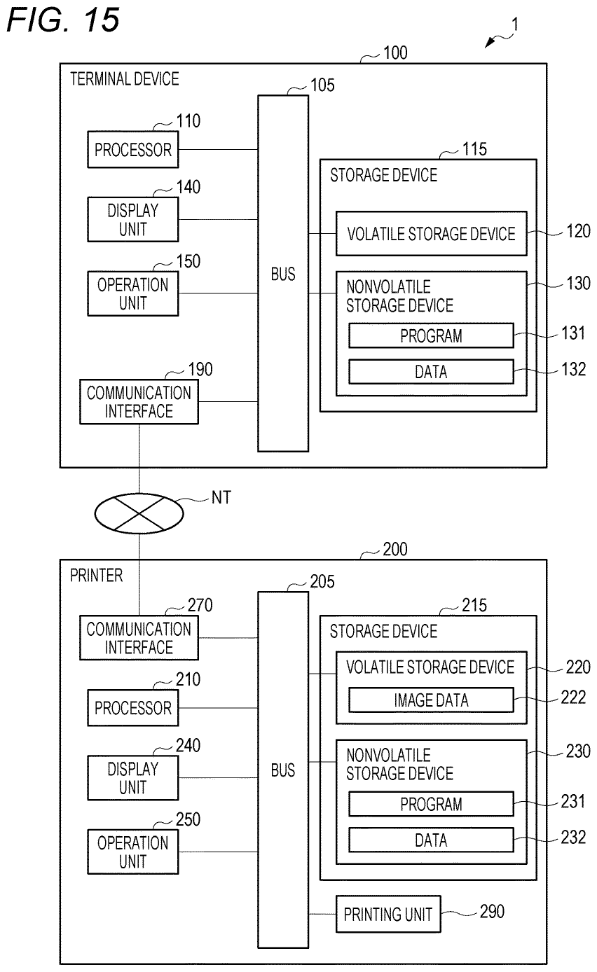

The terminal device 100 is configured to transmit print data to the printer 200 to execute printing. The terminal device 100 is, for example, a desktop PC, a notebook PC, or a tablet computer. Alternatively, the terminal device 100 may be a mobile terminal such as a smartphone. Although details will be described later, the terminal device 100 includes a processor 110 and a storage device 115 configured to store various printing processing programs (see FIG. 15 to be described later). When the processor 110 executes various printing processing programs, the terminal device 100 has the functional configuration illustrated in FIG. 1. In the following description, the description that a program performs * * * means that a process of * * * is executed by the processor 110 executing the program.

As illustrated in FIG. 1, the terminal device 100 includes an operating system (OS) 101, an application 102 corresponding to a printing function of the OS, a printer application 170, a browser 104, a launcher 106, and a database 107. The OS 101 has a so-called driverless printing function of executing printing according to a predetermined printing standard without using a printer driver provided by a printer vendor.

The OS 101 includes, for example, a common unix printing system (CUPS) 160, which is a modularized printing system for the OS. The OS 101 is an example of an operating system, and the CUPS 160 is an example of OS standard printing software.

### CUPS

The CUPS 160 includes an HTTP server 161, a CUPS PnP management unit 162, an IPP client 163, and a print data scheduler & spooler 164.

The HTTP server 161 is server software configured to operate on the CUPS 160. The HTTP server 161 is configured to acquire information and functions using a hypertext transfer protocol (HTTP) via the browser 104, or provide information and functions thereto.

The CUPS PnP management unit 162 has a plug and play (PnP) function of registering, in the CUPS 160, a printer (including a virtual printing device) detected using a protocol such as mDNS/SD to create a print queue.

The CUPS PnP management unit 162 is configured to change the setting so that a search address for PnP is limited to an internal network (normally, IP address 127.0.0.1) of the terminal device 100 by a script executed when the printer application 170 is installed. Therefore, the CUPS 160 cannot directly recognize the printer 200, and recognizes the printer application 170 as a printer. The printer application 170 is not a real printer but a so-called virtual printer that acts as a printer for the CUPS 160. The printer application 170 realizes printing using the CUPS 160 and the printer 200 by mediating between the CUPS 160 and the printer 200. The printer application 170 is an example of a virtual printer.

The IPP client 163 is configured to transmit and receive print data or an attribute to and from an IPP/mDNS server 173 to be described below using the IPP protocol.

The print data scheduler & spooler 164 is configured to manage a print job transmitted from the application 102 or the like, and the print data scheduler & spooler 164 is configured to temporarily block a plurality of print jobs generated at the same time and manage the print jobs to be transferred to the IPP client 163.

### Printer Application

The printer application 170 can be registered in the CUPS 160 as a virtual printer corresponding to the connected printer 200. The CUPS 160 can handle the printer application 170 as a virtual printer and execute various processes related to printing. The various processes include, for example, a capability information acquisition process and a print data transmission process. The printer application 170 includes a printer communication unit 171, an attribute/mDNS conversion unit 172, the IPP/mDNS server 173, a print data conversion unit 174, and a print setting storage unit 175. The printer application 170 is an example of an information processing program.

The printer communication unit 171 is configured to communicate with the printer 200. The printer communication unit 171 is configured to receive capability information from the printer 200 and transmit print data to the printer 200. Communication between the printer communication unit and the printer is performed via a network, a USB, or the like. In the case of a network, protocols such as IPP and LPD are used. As the capability information, an IPP attribute is used in the case of an IPP protocol, and PJL information is used in the case of another interface or protocol such as USB.

The attribute/mDNS conversion unit 172 is configured to acquire, via the printer communication unit 171, capability information representing the capability of the printer 200. The attribute/mDNS conversion unit 172 is configured to convert the capability information acquired from the printer 200 into an IPP attribute corresponding to a printing function that can be handled by the CUPS 160. The IPP attribute/mDNS conversion unit 172 may be configured to convert the attribute based on print setting information read from the print setting storage unit 175.

The attribute/mDNS conversion unit 172 has a function of a multicast domain name system (mDNS). The mDNS is configured to simultaneously distribute a DNS inquiry in a local network by Internet Protocol (IP) multicast, and simultaneously make an inquiry to all devices in the same network. A device that has received the inquiry is configured to transmit its own IP address as a response.

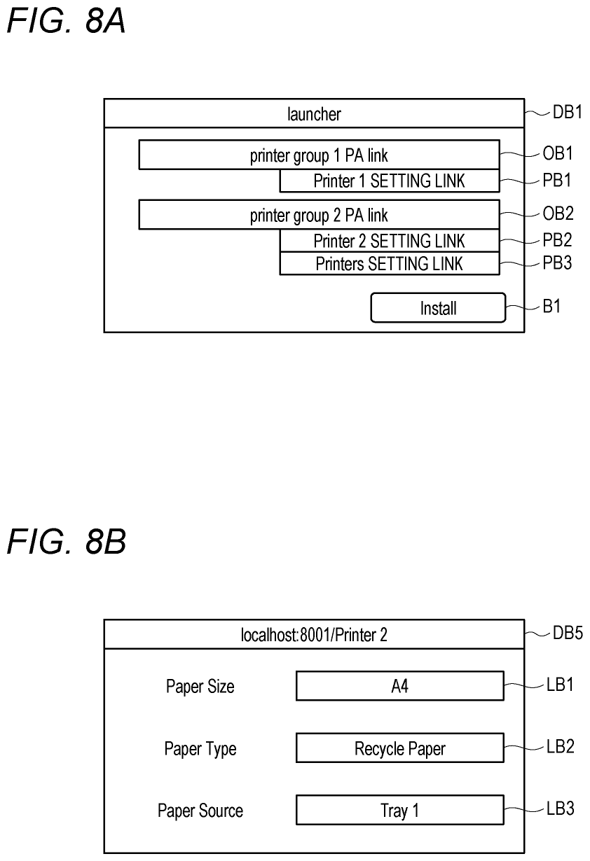

The print setting storage unit 175 is configured to store print setting information of the printer 200 corresponding to the printer application 170. The print setting information includes, for example, a size of the printing sheet, a type of the printing sheet, and a storage location of the printing sheet (see FIG. 8B to be described later). The print setting information is set in the terminal device 100. For example, the setting is made on a print setting screen displayed on a display unit 140 (see FIG. 15 to be described later) by the launcher 106 or via the browser 104. An HTTP server 176 of the printer application 170 is configured to acquire the print setting information set on the print setting screen and store the print setting information in the print setting storage unit 175. The print setting storage unit 175 is, for example, a partial region of the data storage region 132 of a nonvolatile storage device 130 of the storage device 115 of the terminal device 100 (see FIG. 15 to be described later). The print setting is not limited to the terminal device 100, but may be set in an external terminal, or a preset content may be installed in the printer application 170.

In response to the capability information acquisition process of the CUPS 160, the IPP/mDNS server 173 outputs, to the CUPS 160, the attribute converted by the attribute/mDNS conversion unit 172. The CUPS 160 is configured to output print data corresponding to the attribute converted by the IPP client 163. In response to the print data transmission process by the CUPS 160, the IPP/mDNS server 173 acquires print data output from the CUPS 160 and corresponding to the converted attribute, and outputs the print data to the print data conversion unit 174. The IPP/mDNS server 173 has a function of mDNS similarly to the attribute/mDNS conversion unit 172.

The print data conversion unit 174 is configured to acquire print data from the CUPS 160 via the IPP/mDNS server 173. The print data conversion unit 174 is configured to convert the print data acquired from the CUPS 160 into print data corresponding to a printing function of the printer 200. The print data conversion unit 174 may be configured to convert the print data based on the print setting information read from the print setting storage unit 175. The print data conversion unit 174 is configured to output the converted print data to the printer communication unit 171.

The printer communication unit 171 is configured to transmit, to the printer 200, the print data output from the print data conversion unit 174.

The launcher 106 is a program for managing the printer application 170 as a virtual printer. The launcher 106 is configured to receive a user operation and execute various processes. The various processes include, for example, installation of the printer application 170 in the terminal device 100, registration of the printer 200 in the printer application 170, display of a print setting screen of the printer 200, and print setting on the print setting screen. The database 107 is configured to store various kinds of information used when the launcher 106 executes various processes. The various kinds of information include, for example, a port number of the HTTP server 176 of each printer application 170, and a URL of the print setting screen of the printer 200 registered in each printer application 170. The launcher 106 is an example of a virtual printer management program.

### Features of Present Embodiment

For a single printer application 170, not only one printer 200 but also a plurality of printers 200 can be registered. For example, in a case where the user uses a plurality of types of printers, such as a color inkjet printer 200 and a monochrome laser printer 200, depending on the application, the single printer application 170 may not cover functions of these printers. In such a case, a plurality of printer applications 170 are installed in one terminal device 100.

A user interface of the printer application 170 is provided by an HTTP protocol via the HTTP server 176, and the user accesses the print setting screen of the corresponding printer 200 using the browser 104. Normally, access is performed using, for example, URI(URL) of http://localhost:8000, but when the plurality of printer applications 170 are installed as described above, access can be individually performed by changing a location of a port number, for example, as in http://localhost:8001. In this case, the user needs to manage a plurality of port numbers.

In a case where the plurality of printer applications 170 are installed as described above, the print setting screen of each printer 200 is accessed via the corresponding printer application 170. In this case, the user needs to manage which printer 200 is registered in which printer application 170. In addition, it is necessary to investigate which port is assigned to each printer application before access. In this way, the user may be forced to perform complicated management.

In the present embodiment, by implementing the launcher 106, the user can access the print setting screen of a desired printer 200 without being aware of the printer application 170 in which each printer 200 is registered without managing the port number. Hereinafter, this will be described in detail. In the following description, it is assumed that installation packages (printer_group1.deb, printer_group2.deb) of two printer applications are stored in a directory (/home/XXXX) in advance.

### Screen Display by Launcher

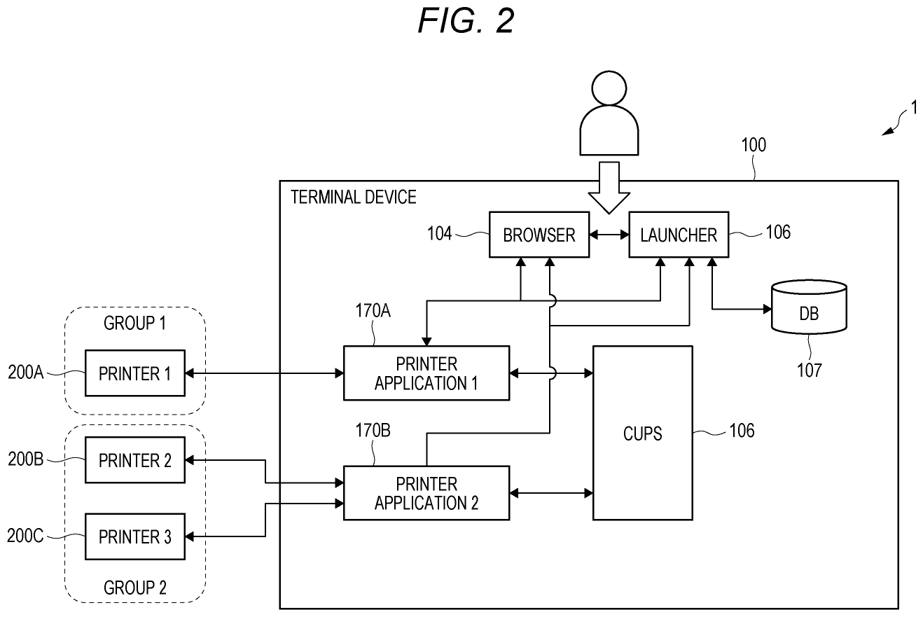

FIG. 2 illustrates a specific example of the printing system 1 when the plurality of printer applications 170 are installed in the terminal device 100. In FIG. 2, the same components as those in FIG. 1 are denoted by the same reference numerals, and description thereof will be omitted. In the example illustrated in FIG. 2, a first printer application 170A and a second printer application 170B are installed in the terminal device 100. The first printer application 170A is configured to manage a first printer 200A, which is one printer. The first printer 200A configures a printer group 1. The second printer application 170B is configured to manage a second printer 200B and a third printer 200C, which are two printers. The second printer 200B and the third printer 200C configure the printer group 2.

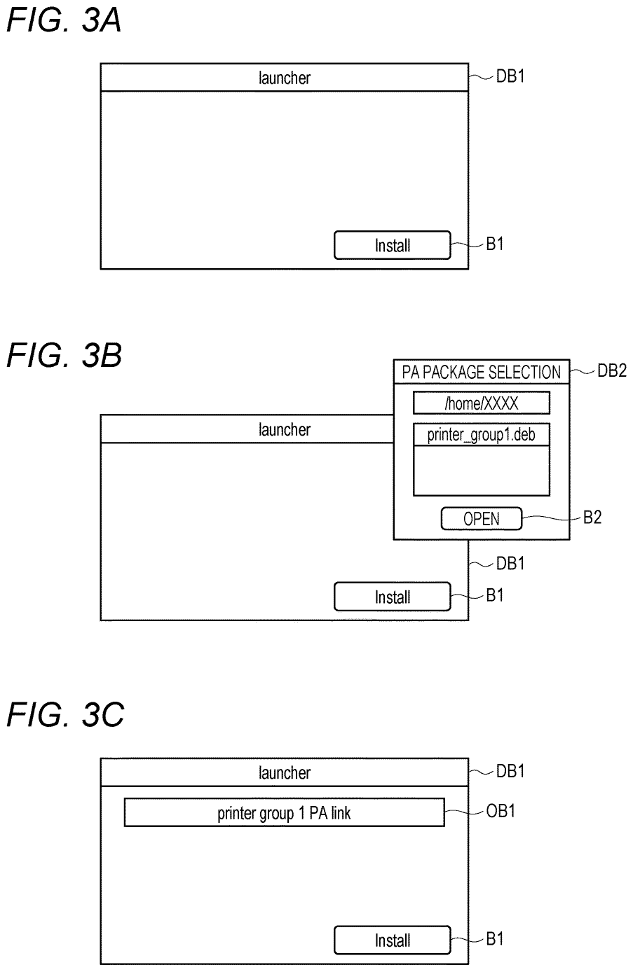

FIGS. 3A to 3C illustrate examples of dialog boxes displayed on the display unit 140 of the terminal device 100 by the launcher 106 in a case where the first printer application 170A is installed in the terminal device 100. FIG. 3A illustrates a state in which no printer application 170 is installed, and only an install button B1 is displayed in a dialog box DB1. As the install button B1 is operated in FIG. 3A, the process proceeds to FIG. 3B.

In FIG. 3B, a package dialog box DB2 displaying a package of the printer application 170 so as to be selected is displayed on the dialog box DB1. In the package dialog box DB2, a directory designation portion (displayed as /home/XXXX in FIG. 3B) configured to designate a directory in which a package is placed and an installable package in the directory are displayed, and a selection button B2 for selecting a package is displayed. In the example illustrated in FIG. 3B, “printer_group1.deb” corresponding to the printer group 1 is displayed as a package. In FIG. 3B, as the package is selected and the selection button B2 is operated, the first printer application 170A is installed in the terminal device 100 and activated and executed. Then, the HTTP server 176 of the printer application 170A is activated, and the localhost:8000 becomes communicable. The launcher 106 is configured to monitor an address of localhost, and as the launcher recognizes that the port localhost:8000 is newly opened by the HTTP server 176 and becomes communicable, the process proceeds to FIG. 3C. At this time, the port number of the HTTP server 176 of the installed first printer application 170A is acquired and stored.

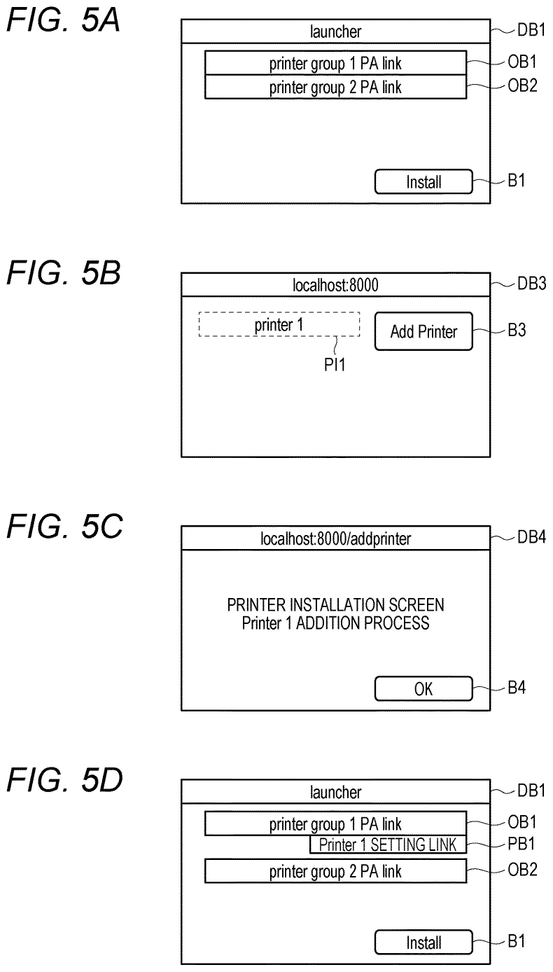

In FIG. 3C, a PA object OB1 representing information of the installed first printer application 170A is displayed in the dialog box DB1. In the example illustrated in FIG. 3C, “printer group1 PA link” indicating the first printer application 170A is displayed in the PA object OB1. The PA object OB1 is associated with the URL (http://localhost:8000) of an addition setting screen of the corresponding printer as a link destination, and as the PA object OB1 is operated, the addition setting screen of the corresponding printer is displayed (see FIGS. 5A to 5D to be described later).

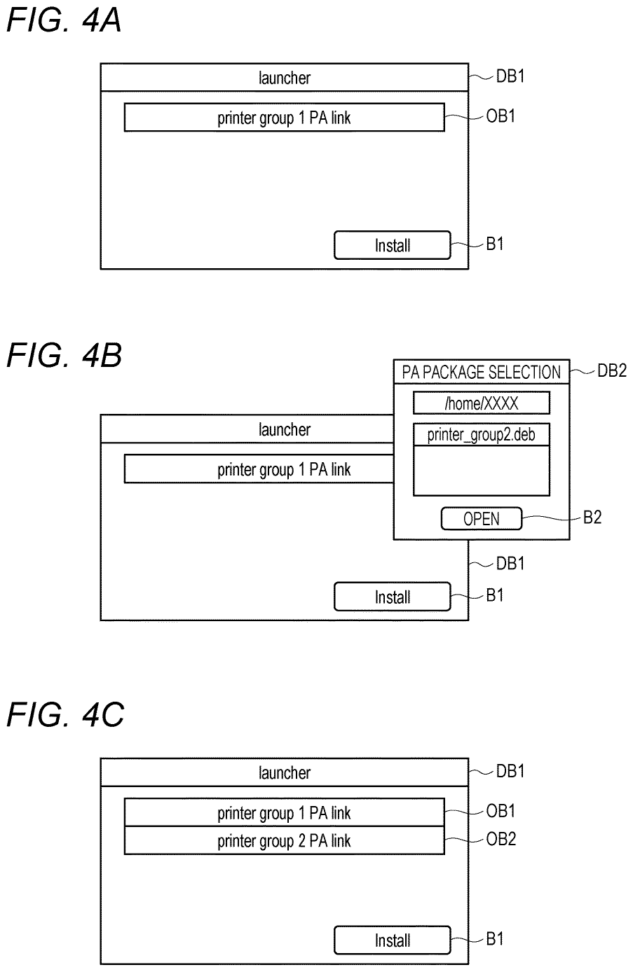

FIGS. 4A to 4C illustrate examples of dialog boxes displayed on the display unit 140 of the terminal device 100 by the launcher 106 in a case where the second printer application 170B is installed in the terminal device 100. FIG. 4A illustrates a state in which the first printer application 170A has already been installed and the second printer application 170B has not yet been installed, and the PA object OB1 is displayed in the dialog box DB1. As the install button B1 is operated in FIG. 4A, the process proceeds to FIG. 4B.

In FIG. 4B, the package dialog box DB2 displaying the package of the printer application 170 so as to be selected is displayed on the dialog box DB1. In the example illustrated in FIG. 4B, “printer_group2.deb” corresponding to the printer group 2 is displayed as a package. As the package is selected in FIG. 4B and the selection button B2 is operated, the second printer application 170B is installed in the terminal device 100, the same process as the first printer application 170A is executed, and the process proceeds to FIG. 4C. At this time, the port number of the HTTP server 176 of the installed second printer application 170B is acquired and stored.

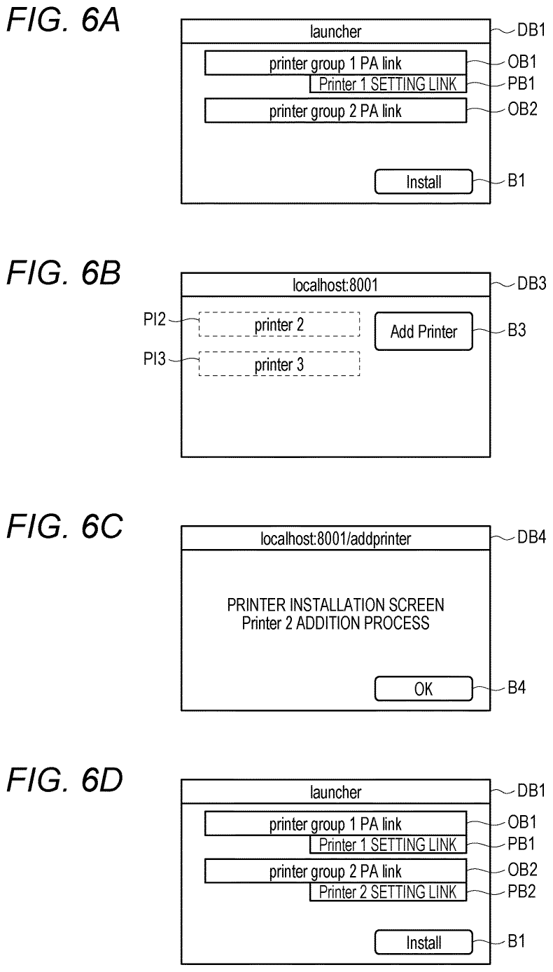

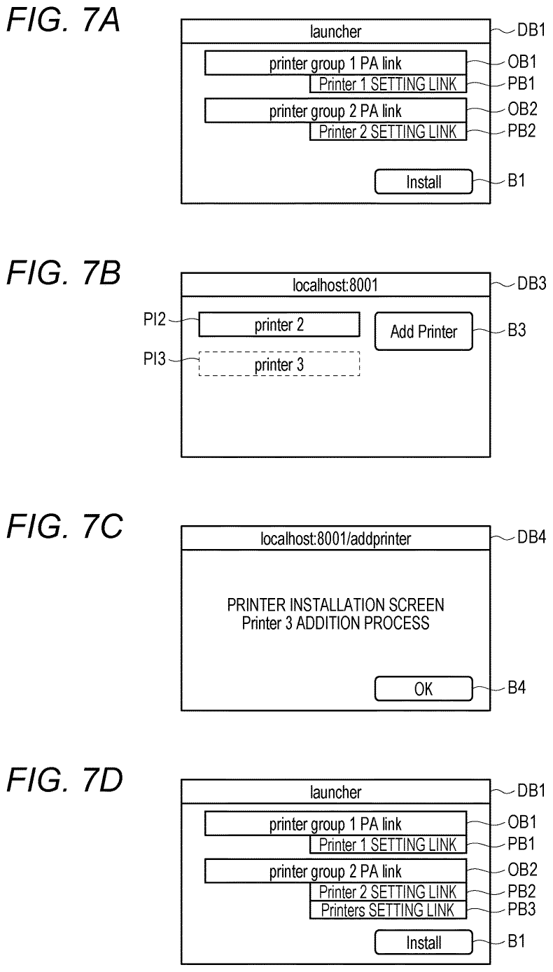

In FIG. 4C, a PA object OB2 representing information of the installed second printer application 170B is displayed in addition to the PA object OB1 in the dialog box DB1. In the example illustrated in FIG. 4C, “printer group2 PA link” indicating the second printer application 170B is displayed in the PA object OB2. In the PA object OB2, the URL (http://localhost:8001) of the addition setting screen of the corresponding printer is linked with a link destination, and as the PA object OB2 is operated, the additional setting screen of the corresponding printer is displayed (see FIGS. 6A and 7D to be described later).

FIGS. 5A to 5D illustrate examples of dialog boxes displayed on the display unit 140 of the terminal device 100 by the launcher 106 in a case where the first printer 200A of the printer group 1 is registered in the first printer application 170A. FIG. 5A is the same screen as FIG. 4C, and PA objects OB1 and OB2 are displayed in the dialog box DB1. As the PA object OB1 is operated in FIG. 5A, the browser 104 is activated, and a display screen in FIG. 5B is newly displayed based on the linked URL.

FIG. 5B illustrates a screen displayed via the browser 104. Data constituting contents displayed via the browser 104 is generated by the HTTP server 176 of the printer application 170A, and has a UI for registering a printer. FIGS. 5B and 5C illustrate screens displayed by the HTTP server 176 via the browser 104, and processes corresponding to the screen operation are executed by the printer application 170A. In FIG. 5B, a dialog box DB3, which is an addition setting screen of a printer for the first printer application 170A, is displayed. In the example illustrated in FIG. 5B, the URL of the dialog box DB3 is, for example, http://localhost:8000. “8000” of the URL represents the port number of the HTTP server 176 of the first printer application 170A. In the dialog box DB3, a printer display PI1 for selecting the first printer 200A that can be added and an addition button B3 for registering the first printer 200A are displayed. The printer display PI1 displays the printer searched by the mDNS by the first printer application 170A. As the first printer 200A is selected in FIG. 5B and the install button B3 is operated, the process proceeds to FIG. 5C.

FIG. 5C is also a screen displayed via the browser 104. In FIG. 5C, a dialog box DB4, which is an installation screen of the first printer 200A, is displayed. In the example illustrated in FIG. 5C, the URL of the dialog box DB4 is, for example, http://localhost:8000/addprinter. In the dialog box DB4, a display for executing a process of adding the first printer 200A to the first printer application 170A and an OK button B4 are displayed. As the printer application 170A executes the process of adding the first printer 200A, the HTTP server 176 allows localhost:8000/printer1 to be accessed. As the OK button B4 is operated in FIG. 5C, the browser 104 ends. The launcher 106 monitors localhost:8000/, and as recognizing that localhost:8000/printer1 becomes available, a display screen by the launcher 106 shifts to a display screen in FIG. 5D.

In FIG. 5D, the PA objects OB1 and OB2 are displayed in the dialog box DB1, and a printer object PB1 for selecting the first printer 200A is displayed in association with the PA object OB1. In the example illustrated in of FIG. 5D, the printer object PB1 is displayed hierarchically under the PA object OB1, so that the first printer 200A is managed by the first printer application 170A that manages the printer group 1. A URL (localhost:8000/printer1) of the corresponding print setting screen is associated with the printer object PB1 as a link destination, and as the printer object PB1 is operated, the browser 104 is activated, and the print setting screen of the first printer 200A generated by the HTTP server 176 is displayed. The printer object PB1 is an example of a selection object, and the URL of the print setting screen is an example of a setting screen address.

FIGS. 6A to 6D illustrate examples of dialog boxes displayed on the display unit 140 of the terminal device 100 by the launcher 106 in a case where the second printer 200B of the printer group 2 is registered in the second printer application 170B. FIG. 6A is the same screen as FIG. 5D, and the PA objects OB1 and OB2 and the printer object PB1 are displayed in the dialog box DB1. As the PA object OB2 is operated in FIG. 6A, the browser 104 is activated, and the display screen in FIG. 6B is newly displayed based on the linked URL.

FIG. 6B illustrates a screen displayed via the browser 104. In FIG. 6B, the dialog box DB3, which is an addition setting screen of a printer for the second printer application 170B, is displayed by the browser 104. In the example illustrated in FIG. 6B, the URL of the dialog box DB3 is, for example, http://localhost:8001. “8001” of the URL represents the port number of the HTTP server 176 of the second printer application 170B. The dialog box DB3 is displayed by the HTTP server 176 via the browser 104, and there are displayed a printer display PI2 for selecting the second printer 200B that can be added, a printer display PI3 for selecting the third printer 200C that can be added, and the addition button B3. In the printer displays PI2 and PI3, printers searched by the mDNS by the second printer application 170B are displayed. As the second printer 200B is selected in FIG. 6B and the install button B3 is operated, the process proceeds to FIG. 6C.

FIG. 6C is also a screen displayed by the HTTP server 176 via the browser 104. In FIG. 6C, the dialog box DB4, which is an installation screen of the second printer 200B, is displayed. In the example illustrated in FIG. 6C, the URL of the dialog box DB4 is, for example, http://localhost:8001/addprinter. In the dialog box DB4, a display for executing a process of adding the second printer 200B to the second printer application 170B and an OK button B4 are displayed. As the OK button B4 is operated in FIG. 6C, the browser 104 ends, and a display screen in FIG. 6D is newly displayed by the launcher 106.

In FIG. 6D, the PA objects OB1 and OB2 are displayed in the dialog box DB1, and a printer object PB2 for selecting the second printer 200B is displayed in association with the PA object OB2. In the example illustrated in FIG. 6D, the printer object PB2 is displayed hierarchically under the PA object OB2, so that the second printer 200B is managed by the second printer application 170B that manages the printer group 2. The URL of the corresponding print setting screen is associated with the printer object PB2 as a link destination, and as the printer object PB2 is operated, a print setting screen of the second printer 200B is displayed (see FIGS. 8A and 8B to be described later). The printer object PB2 is an example of a selection object, and the URL of the print setting screen is an example of a setting screen address.

FIGS. 7A to 7D illustrate examples of dialog boxes displayed on the display unit 140 of the terminal device 100 in a case where the third printer 200C of the printer group 2 is registered in the second printer application 170B. FIG. 7A is the same screen as FIG. 6D, and the PA objects OB1 and OB2 and the printer objects PB1 and PB2 are displayed in the dialog box DB1 by the launcher 106. As the PA object OB2 is operated in FIG. 7A, the browser 104 is activated, and a display screen in FIG. 7B is displayed by the HTTP server 176 via the browser 104 based on the linked URL.

In FIG. 7B, the dialog box DB3, which is an addition setting screen of a printer for the second printer application 170B, is displayed. In the dialog box DB3, a printer display PI2 indicating the added second printer 200B, a printer display PI3 for selecting the third printer 200C that can be added, and the addition button B3 are displayed. The printer display PI3 displays the printer searched by the mDNS by the second printer application 170B. The printer displays PI2 and PI3 are displayed in different modes so that completion or non-completion of installation can be distinguished. As the third printer 200C is selected in FIG. 7B and the install button B3 is operated, the process proceeds to FIG. 7C.

FIG. 7C also illustrates a screen displayed by the HTTP server 176 via the browser 104. In FIG. 7C, a dialog box DB4, which is an installation screen of the third printer 200C, is displayed. In the dialog box DB4, a display for executing a process of adding the third printer 200C to the second printer application 170B and the OK button B4 are displayed. As the OK button B4 is operated in FIG. 7C, the browser 104 ends, and a display screen in FIG. 7D is displayed by the launcher 106.

In FIG. 7D, the PA objects OB1 and OB2 are displayed in the dialog box DB1, and a printer object PB3 for selecting the third printer 200C is displayed in association with the PA object OB2. In the example illustrated in FIG. 7D, the printer object PB3 is displayed hierarchically under the PA object OB2, so that the third printer 200C is managed by the second printer application 170B that manages the printer group 2. The URL of the corresponding print setting screen is associated with the printer object PB3 as a link destination, and as the printer object PB3 is operated, a print setting screen of the third printer 200C by the printer application 170B is displayed via the browser 104. The printer object PB3 is an example of a selection object, and the URL of the print setting screen is an example of a setting screen address.

FIGS. 8A and 8B illustrate examples of dialog boxes displayed on the display unit 140 of the terminal device 100 in a case where the user selects the desired printer 200 and displays a print setting screen. FIG. 8A is the same screen as FIG. 7D, and the PA objects OB1 and OB2 and the printer objects PB1, PB2, and PB3 are displayed in the dialog box DB1 by the launcher 106. In the dialog box DB1, the user can select one of the printers 200 by operating one of the printer objects PB1, PB2, and PB3. The dialog box DB1 is an example of a selection screen. As the printer object PB2 is operated in FIG. 8A, the browser 104 is activated, and a display screen in FIG. 8B is displayed by the HTTP server 176 based on the linked URL.

FIG. 8B illustrates a screen displayed via the browser 104. In FIG. 8B, a dialog box DB5, which is the print setting screen of the second printer 200B generated by the printer application 170B, is displayed. In the example illustrated in FIG. 8B, the URL of the dialog box DB5 is, for example, http://localhost:8001/Printer2. “8001” of the URL represents the port number of the HTTP server 176 of the second printer application 170B. In the dialog box DB5, as a print setting of the second printer 200B, for example, a list box LB1 capable of selecting a size of a printing sheet, a list box LB2 capable of selecting a type of a printing sheet, and a list box LB3 capable of selecting a storage location of a printing sheet are displayed. In the example illustrated in FIG. 8B, A4 is set as the size of the printing sheet, recycled paper is set as the type of the printing sheet, and a tray 1 is set as the storage location of the printing sheet. Items other than those described above may be set on the print setting screen.

In a state where the installation of the printer application 170 and the registration of the printer 200 in each printer application 170 are completed, as the launcher 106 is activated, the dialog box DB1 illustrated in FIG. 8A is displayed. The user can open the print setting screen of the corresponding printer 200 only by operating the printer objects PB1, PB2, and PB3 corresponding to the desired printer 200 in the dialog box DB1. Accordingly, the user does not need to manage the port number, and can access the print setting screen of the desired printer 200 without being aware of which printer application 170 manages each printer 200.

### Control Procedure

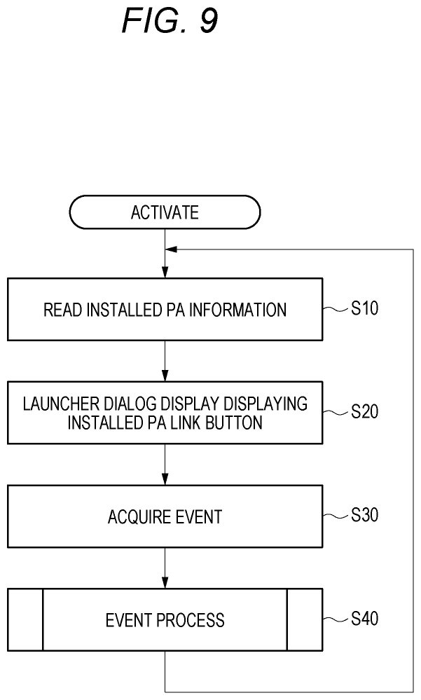

A control procedure executed by the launcher 106 to realize the above-described screen display will be described with reference to flowcharts of FIGS. 9 to 14. FIG. 9 illustrates an example of a control procedure executed when the launcher 106 is activated.

As illustrated in FIG. 9, in step S10, the launcher 106 checks a target port (after 8000) of an address (normally, localhost) of the target terminal device 100 to read information related to the printer application 170 installed in the terminal device 100. The read information includes, for example, identification information of the installed printer application 170, a port number of the HTTP server 176 of each printer application 170, and a URL of the print setting screen of the printer 200 registered in each printer application 170.

In step S20, based on the information read in step S10, the launcher 106 causes the display unit 140 of the terminal device 100 to display the dialog box DB1 displaying a link button of the installed printer application 170 and a link button of the printer 200. In a state where the printer application has not yet been installed, the printer application is displayed as illustrated in FIG. 3A. As the launcher 106 is started again after the series of processes end, the launcher 106 is displayed as illustrated in FIG. 6D. Even when the printer application 170 is independently installed without using the launcher 106, the printer application 170 is similarly displayed. The link buttons are, for example, the PA objects OB1 and OB2 and the printer objects PB1, PB2, and PB3 described above. That is, in step S20, selection screen display data for causing the display unit 140 of the terminal device 100 to display the dialog box DB1 in which the plurality of printers 200 corresponding to the plurality of printer applications 170 are selectable is output from the launcher 106 to the display unit 140. Step S20 is an example of the selection screen display process.

In step S30, the launcher 106 acquires an event that has occurred. The event is an event corresponding to each of step S100, step S200, step S300, and step S400 to be described later.

In step S40, the launcher 106 executes a process corresponding to the event acquired in step S30. Then, the process returns to the step S10. In this way, step S10 to step S40 are repeated.

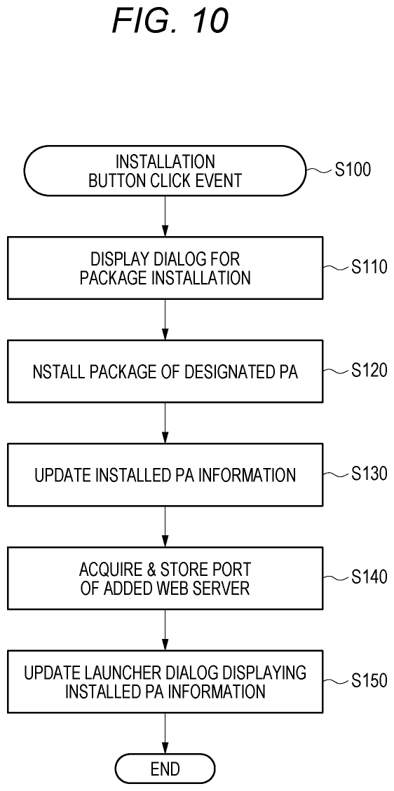

FIG. 10 illustrates an example of a control procedure executed by the launcher 106 when step S100, which is a click event of the install button B1, occurs as the event.

As illustrated in FIG. 10, in step S110, the launcher 106 displays the package dialog box DB2 for package installation on the display unit 140 of the terminal device 100. The package dialog box DB2 displays the package for each of the plurality of printer applications 170 to be selectable, based on an operation of the install button B1 in the dialog box DB1 described above. An operation of the install button B1 is an example of a predetermined operation on the display unit 140, and step S110 is an example of a package display process.

In step S120, the launcher 106 receives the selection of a package in the package dialog box DB2 displayed in step S110, and executes the installation of the package of the selected printer application 170. In step S110 and step S120, installation is received for each of the plurality of printer applications 170. Step S110 and Step S120 are an example of the installation reception process.

In step S130, the launcher 106 updates information related to the installed printer application 170 stored in the database 107.

In step S140, the launcher 106 acquires the port number of the HTTP server 176, which is a WEB server of the added printer application 170, and stores the port number in the database 107. The port number is an example of port information, and step S140 is an example of a port information storage process.

In a case where the package designated in step S120 is not the printer application 170, an event handling process ends (not illustrated) when an error exception process is set and the package is uninstalled.

In step S150, the launcher 106 updates the dialog box DB1 displaying the link button of the installed printer application 170. That is, the dialog box DB1 is updated so that the link button of the printer application 170 installed in step S120 is added. Thus, this flowchart ends.

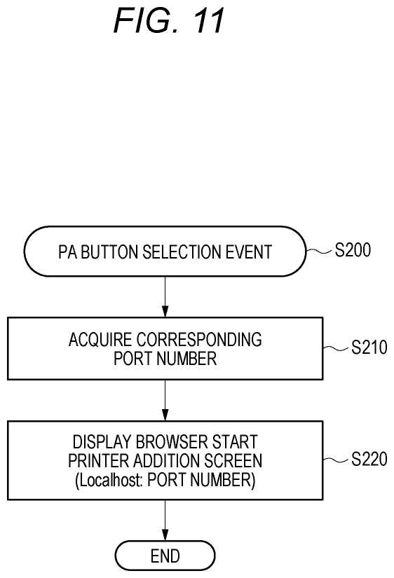

FIG. 11 illustrates an example of a control procedure executed by the launcher 106 when step S200, which is a button selection event of the printer application 170, occurs as the event. The buttons of the printer application 170 in step S200 are, for example, the PA objects OB1 and OB2 to be described above.

In step S210, the launcher 106 reads and acquires the port number of the HTTP server 176 of the printer application 170 corresponding to the selected button from the database 107. The port number of the printer application 170 is stored in the database 107 in the above-described step S140 when installed. Step S210 is an example of a port information acquisition process.

In step S220, the launcher 106 starts the browser 104, and causes the display unit 140 of the terminal device 100 to display an addition setting screen for adding the designated printer 200 to the printer application 170, based on the URL including the port number acquired in step S210. In step S220, display data for displaying the addition setting screen is output from the launcher 106 to the browser 104. The URL is, for example, http://localhost:****. “****” indicates the port number acquired in step S210. That is, in step S220, the transition to the addition setting screen of the printer 200 associated with the printer application 170 corresponding to the port number acquired in step S210 is executed. Step S220 is an example of a printer addition screen shift process. Thus, this flowchart ends.

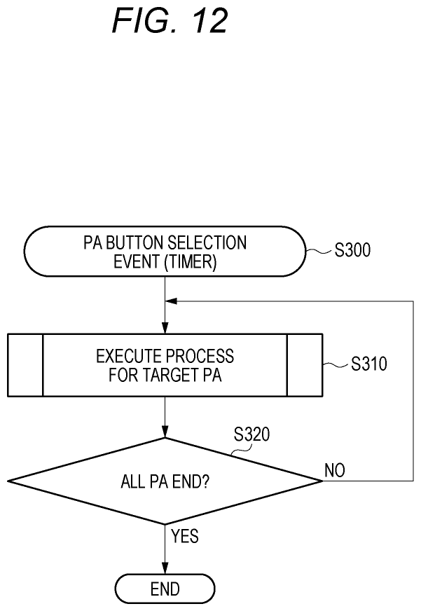

FIG. 12 illustrates a timer event process executed by a timer at regular time intervals (for example, every second).

In step S310, the launcher 106 executes a process for the printer application 170 to be processed corresponding to the selected button. Details of the process in step S310 will be described later.

In step S320, the launcher 106 determines whether the execution of step S310 has been ended for all the printer applications 170 installed in the terminal device 100. If the launcher 106 has not ended the execution of step S310 for all the printer applications 170 (step S320: No), the launcher 106 returns to step S310. On the other hand, when the launcher 106 ends the execution of step S310 for all the printer applications 170 (step S320: Yes), the launcher 106 ends this flowchart.

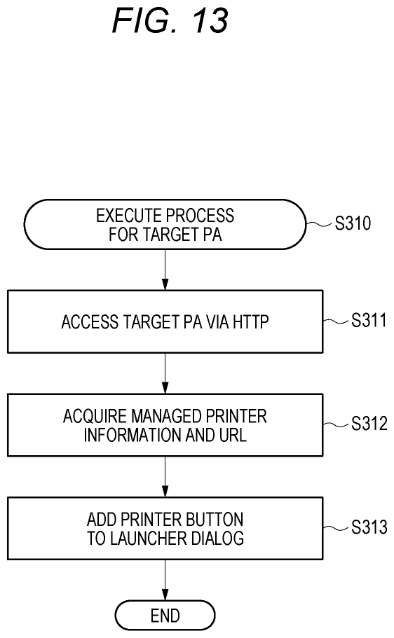

FIG. 13 illustrates an example of a control procedure executed by the launcher 106 in the process for the printer application 170 to be processed in step S310.

In step S311, the launcher 106 reads and acquires, from the database 107, the port number of the HTTP server 176 of the printer application 170 to be processed. Next, the launcher 106 accesses the printer application 170 to be processed via the HTTP protocol, based on the URL including the acquired port number. Step S311 is an example of an information processing program access process.

In step S312, the launcher 106 acquires information related to a managed printer and a URL of the print setting screen of the managed printer from the printer application 170 accessed in step S311. The information related to the managed printer and the URL of the print setting screen of the managed printer are an example of printing device information related to the printing device, the URL is an example of a setting screen address to the print setting screen, and step S312 is an example of a printing device information acquisition process.

In step S313, the launcher 106 updates (adds or deletes) a printer button corresponding to the information on the managed printer acquired in step S312 to the dialog box DB1 displaying the link button of the installed printer application 170. The URL acquired in step S312 is associated with the printer button as a link destination. The printer button in step S313 is, for example, the above-described printer objects PB1, PB2, and PB3. Thus, this flowchart ends.

That is, as the user clicks the button of the printer application 170, an operation screen of the printer application 170 is displayed via the browser 104, and as the printer 200 is additionally registered or deleted on the screen, a screen displayed by the launcher 106 is updated in step S313 of a timer event that occurs thereafter.

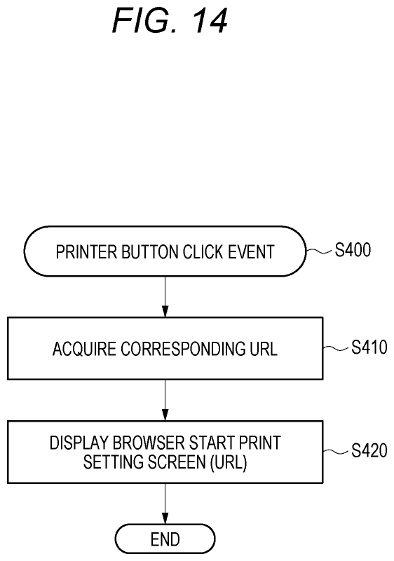

FIG. 14 illustrates an example of a control procedure executed by the launcher 106 when step S400, which is a click event of a printer button, occurs as the event. The printer button in step S400 is, for example, the above-described printer objects PB1, PB2, and PB3. In the click event of the printer button, a selection operation of one printer 200 among the plurality of printers 200 is received in the displayed dialog box DB1. Specifically, the dialog box DB1 displayed in step S20 described above includes a plurality of printer objects PB1, PB2, and PB3 for selecting each of the plurality of printers 200. The URL to the corresponding print setting screens is linked to the plurality of printer objects PB1, PB2, and PB3 as link destinations (localhost:8000/printer1, localhost:8000/printer2, and localhost:8000/printer3). In step S400, one printer object among the plurality of printer objects PB1, PB2, and PB3 is operated to receive a selection operation of one printer 200. Step S400 is an example of selection reception process.

In step S410, the launcher 106 reads and acquires, from the database 107, the URL of the print setting screen of the printer 200 corresponding to the clicked button.

In step S420, the launcher 106 starts the browser 104, and causes the display unit 140 of the terminal device 100 to display the print setting screen of the printer 200 corresponding to the clicked printer button, based on the URL acquired in step S410. In step S420, display data for displaying the print setting screen is output from the printer application 170 to the browser 104. In step S420, a process for displaying the print setting screen of the clicked one printer 200 on the display unit 140 of the terminal device 100 is executed for one printer application 170 corresponding to the clicked one printer 200. Specifically, the print setting screen is displayed on the browser 104 of the terminal device 100, using the URL of the one printer application 170 corresponding to the clicked one printer 200. The URL is, for example, http://localhost:8001 and printer2 of the directory indicating the printer 200. Therefore, step S420 can also be said to be a process based on the port number corresponding to one printer application 170 corresponding to the clicked one printer 200. The user can instruct the printer application 170 to perform individual setting of the target printer 200 on this screen. Step S420 is an example of a setting screen activation process. Thus, this flowchart ends.

As described above, the second printer application 170B corresponds to the second printer 200B and the third printer 200C among the plurality of printers 200. Therefore, in a case where the button corresponding to the second printer 200B is clicked, in step S420, the launcher 106 executes a process for causing the second printer application 170B to display the print setting screen of the second printer 200B on the display unit 140. In a case where the button corresponding to the third printer 200C is clicked, in step S420, the launcher 106 executes a process of causing the second printer application 170B to display a print setting screen of the third printer 200C on the display unit 140. The second printer 200B is an example of a first printing device, and the third printer 200C is an example of a second printing device.

### Effects of Embodiment

In the printing system 1 according to the present embodiment, as the launcher 106 is activated in the terminal device 100, step S20, step S400, and step S420 are executed. In step S20, the dialog box DB1 in which the plurality of printers 200 corresponding to the plurality of printer applications 170 are selectable is displayed on the display unit 140 of the terminal device 100. In step S400, a selection operation of one printer 200 among the plurality of printers 200 is received in the displayed dialog box DB1. In step S420, a process for causing one printer application 170 corresponding to the one printer 200 received in step S400 among the plurality of printer applications 170 to display, on the display unit 140 of the terminal device 100, the print setting screen of one printer 200 for which the selection operation has been received is executed.

According to the present embodiment, the user can display the print setting screen of the printer 200 on the display unit 140 of the terminal device 100 by performing an operation of selecting the desired printer 200 in the dialog box DB1. Accordingly, the user can execute a print setting without accessing the printer application 170 corresponding to the desired printer 200 by, for example, inputting a port number, a URL, or the like in the browser 104. Therefore, the user can execute a unique print setting by the printer application 170 corresponding to the desired printer 200 without executing a process according to the printer application 170.

Further, particularly in the present embodiment, in step S420, the print setting screen is displayed via the browser 104 using the URL of one printer application 170 corresponding to the one printer 200 received in step S400. Accordingly, the user can save the trouble of inputting the URL in the browser 104 in order to access the print setting screen, thereby improving the convenience of the user.

In the present embodiment, in particular, by a simple operation of selecting one printer object from the plurality of printer objects PB1, PB2, and PB3 displayed in the dialog box DB1, the user can cause the display unit 140 of the terminal device 100 to display the print setting screen of the printer 200 corresponding to the selected printer object. Accordingly, the operability of the user can be improved.

In the present embodiment, in particular, the launcher 106 executes step S110, step S120, and step S140. In step S110 and step S120, installation is received for each of the plurality of printer applications 170. In step S140, a plurality of port numbers corresponding to the plurality of printer applications 170 are stored when the plurality of printer applications 170 received in step S110 and step S120 are installed. Thereby, in step S420, by reading a port number corresponding to one printer application 170 corresponding to the one printer 200 for which the selection operation has been received, it is possible to display the print setting screen of the desired printer 200 based on the URL including the port number. Further, since the corresponding port number is automatically stored when the printer application 170 is installed, it is not necessary for the user to manage the port number, and convenience can be improved.

In particular, in the present embodiment, step S110 is executed in response to a predetermined operation of the user on the display unit 140 of the terminal device 100, and packages are displayed on the display unit 140 for each of the plurality of printer applications 170 to be selectable. Accordingly, when the user appropriately selects one of the displayed packages, the user can select and install the printer application 170 corresponding to the printer 200 that the user wants to print.

In the present embodiment, in particular, after the port number stored in the database 107 is read in step S210 as described above, step S220 is executed using the read port number, so that the transition to the addition setting screen of the corresponding printer 200 can be smoothly performed.

In the present embodiment, in particular, the target printer application 170 is accessed in step S311 using the port number acquired as described above. Then, the information and URL related to the managed printer related to the printer 200 associated with the accessed printer application 170 are acquired in step S312. The acquired information includes the URL to the print setting screen. Accordingly, in step S313, the printer objects PB1, PB2, and PB3 for selecting the printer 200 can be smoothly generated and displayed to correspond to the acquired URL.

In the present embodiment, in particular, one printer application 170 can support the plurality of printers 200. When any one of the plurality of printers 200 is selected, the corresponding one printer application 170 executes a process of displaying the print setting screen of the selected printer 200. Accordingly, the user can select the desired printer 200 without being aware of which printer 200 corresponds to which printer application 170.

### Modification

The present invention is not limited to the above-described embodiment, and various modifications are possible without departing from the gist and technical idea of the above-described embodiment.

For example, in the above embodiment, a printer object is displayed hierarchically under a PA object in the dialog box DB1, but the present invention is not limited thereto. Since the user does not need to worry about which printer application 170 corresponds to which printer 200, the printer 200 corresponding to each printer application 170 may not be displayed. For example, only the printer objects may be displayed side by side without displaying the PA objects. However, the launcher 106 manages the correspondence between the printer application 170 and the printer 200 regardless of the display.

In the above embodiment, the launcher 106 directly displays the dialog boxes DB1 and DB2 on the display unit 140, and the printer application 170 displays the dialog boxes DB3, DB4, and DB5 on the display unit 140 via the browser 104, but the present invention is not limited thereto. For example, the printer application 170 may directly display the dialog boxes DB3, DB4, and DB5 on the display unit 140 without using the browser 104. The launcher 106 may display the dialog boxes DB1 and DB2 on the display unit 140 via the browser 104. The division between the one displayed on the direct display unit 140 and the one displayed via the browser 104 may be other than the above.

Further, in the above-described embodiment, the reading of the installed printer application 170 in step S10 is limited to the terminal device 100 itself, but the reading may be performed on the printer application 170 installed in another terminal device. Information of the printer application 170 installed in another terminal device can be acquired by a function such as mDNS/SD.

The flowcharts illustrated in FIGS. 9 to 14 do not limit the present disclosure to the procedures illustrated in the above flow, and addition, deletion, change in the order, and the like of the procedures may be made without departing from the gist and the technical idea of the invention.

In addition to the above, the methods according to the embodiment and the modifications may be appropriately combined and used.

In addition, although not shown, the present invention may be carried out with various modifications within a scope not departing from the gist thereof.

### Hardware Configuration of Terminal Device and Printer

An example of a hardware configuration of the terminal device 100 and the printer 200 will be described with reference to FIG. 15.

### Terminal Device

As illustrated in FIG. 15, the terminal device 100 includes the processor 110, the storage device 115, the display unit 140, an operation unit 150, and a communication interface 190. The processor 110, the storage device 115, the display unit 140, the operation unit 150, and the communication interface 190 are connected to each other via a bus 105 to be able to transmit and receive data.

The storage device 115 includes a volatile storage device 120 and the nonvolatile storage device 130. The volatile storage device 120 is, for example, a DRAM, and stores various programs and data to be processed. The nonvolatile storage device 130 is, for example, a hard disk drive or a solid state drive, and includes a program storage region 131 and the data storage region 132.

Various programs are stored in the program storage region 131. The various programs include the printer application 170, the printing processing programs, and the like described above based on the flowcharts of FIGS. 9 to 14 described above. The data storage region 132 stores data and the like necessary for executing various programs.

The processor 110 is a device configured to execute data processing, for example, a CPU, and executes various programs stored in the program storage region 131. The processor 110 executes various processes including data communication with the printer 200 connected to a network NT. The processor 110 and the programs stored in the program storage region 131 are examples of a calculation unit and a controller.

The display unit 140 is, for example, a liquid crystal display, and may display various kinds of information. The operation unit 150 is, for example, a keyboard or a button, and receives an input operation by the user. The user may operate the operation unit 150 to input various instructions to the terminal device 100.

The communication interface 190 is an interface for communicating with other devices, and is connected to the network NT. The communication interface 190 is an example of a communication I/F.

The storage device 115 is not limited to the configuration of the above-described device elements, and may be implemented by, for example, a RAM, a ROM, an EEPROM, an HDD, a portable recording medium such as a USB memory attached to and detached from the terminal device 100, a buffer included in the processor 110, or a combination thereof.

The storage device 115 may be a computer-readable storage medium. The computer-readable storage medium is a non-transitory medium. The non-transitory medium also includes a recording medium such as a CD-ROM or a DVD-ROM, in addition to the above-described examples. The non-transitory medium is also a tangible medium. The same applies to a storage device 215 of the printer 200 to be described later.

### Printer

As illustrated in FIG. 15, the printer 200 includes a processor 210, a storage device 215, a display unit 240, an operation unit 250, a communication interface 270, and a printing unit 290. The processor 210, the storage device 215, the display unit 240, the operation unit 250, the communication interface 270, and the printing unit 290 are connected to each other via a bus 205 to be able to transmit and receive data.

The storage device 215 includes a volatile storage device 220 and a nonvolatile storage device 230. The volatile storage device 220 is, for example, a DRAM, and includes an image data storage region 222 that stores image data to be printed. The nonvolatile storage device 230 is, for example, an NVRAM, and a flash memory, and includes a program storage region 231 and a data storage region 232. Various programs are stored in the program storage region 231. The various programs include firmware such as printing processing programs. The data storage region 232 stores various data and the like for executing the various programs.

The processor 210 is a device that executes data processing, and is, for example, a processor such as a CPU. The processor 210 executes various programs stored in the program storage region 231.

The display unit 240 is, for example, a liquid crystal display, and may display various kinds of information. The operation unit 250 is a device that receives an operation by the user. The user may operate the operation unit 250 to input various instructions to the printer 200. The communication interface 270 is a wired or wireless network interface for communicating with other devices, and is connected to the network NT.

The printing unit 290 prints an image on a label tape 201 conveyed by a conveyance device 265. The printing unit 290 prints an image on the label tape 201 based on print data transmitted from the terminal device 100 or print data generated by the printing unit 290 based on an operation on the operation unit 250.

What is claimed is

1. A non-transitory computer readable storage medium storing a virtual printer management program executable by a processor of an information processing device,
the information processing device being configured to be connected to a plurality of printing devices,
the information processing device including:
OS standard printing software that is installed as standard in an operating system and is configured to execute driverless printing that performs printing without using a driver provided by a printer vendor; and
a plurality of information processing programs registered in the OS standard printing software as virtual printers corresponding to the plurality of printing devices,
wherein the virtual printer management program is configured to, when executed by the processor, cause a controller of the information processing device to execute:
a selection screen display process of outputting selection screen display data for causing a display unit of the information processing device to display a selection screen that allows a selection of the plurality of printing devices corresponding to the plurality of information processing programs registered in the OS standard printing software as the virtual printers;
a selection reception process of receiving, on the displayed selection screen, a selection operation of selecting one printing device among the plurality of printing devices; and
a setting screen activation process of executing a process of causing one information processing program corresponding to the one printing device received in the selection reception process, among the plurality of information processing programs registered in the OS standard printing software as the virtual printers corresponding to the plurality of printing devices, to display a print setting screen of the one printing device received in the selection reception process on the display unit of the information processing device.

2. The non-transitory computer readable storage medium according to claim 1,
wherein in the setting screen activation process, a setting screen address of the one information processing program corresponding to the one printing device received in the selection reception process is used such that a browser of the information processing device displays the print setting screen corresponding to the setting screen address.

3. The non-transitory computer readable storage medium according to claim 2,
wherein the selection screen displayed in the selection screen display process includes a plurality of selection objects for selecting each of the plurality of printing devices, the plurality of selection objects being associated with setting screen addresses to corresponding print setting screens as link destinations, and
in the selection reception process, a selection operation of operating one selection object among the plurality of selection objects to select the one printing device is received.

4. The non-transitory computer readable storage medium according to claim 2,
wherein the virtual printer management program is further configured to cause the controller of the information processing device to execute:
an installation reception process of receiving installation for each of the plurality of information processing programs; and
a port information storage process of storing a plurality of pieces of port information corresponding to the plurality of information processing programs, in a case where the plurality of information processing programs received in the installation reception process is installed,
the setting screen activation process includes a process based on one of the plurality of pieces of port information corresponding to one information processing program corresponding to the one printing device for which the selection operation is received in the selection reception process.

5. The non-transitory computer readable storage medium according to claim 4,
wherein the plurality of pieces of port information corresponding to the plurality of information processing programs are information in a URI format.

6. The non-transitory computer readable storage medium according to claim 4,
wherein the installation reception process includes a package display process of displaying a package for each of the plurality of information processing programs so as to be selected, based on a predetermined operation on the display unit, and
the selection of the package displayed in the package display process is received in the installation reception process.

7. The non-transitory computer readable storage medium according to claim 4,
wherein the virtual printer management program is further configured to cause the controller of the information processing device to execute:
a port information acquisition process of reading and acquiring the port information stored in the port information storage process; and
a printer addition screen shift process of shifting to an addition setting screen of the printing device corresponding to the information processing program corresponding to the port information acquired in the port information acquisition process.

8. The non-transitory computer readable storage medium according to claim 7,
wherein the virtual printer management program is further configured to cause the controller of the information processing device to execute:
an information processing program access process of accessing the information processing program to be processed, based on the port information acquired in the port information acquisition process; and
a printing device information acquisition process of acquiring printing device information related to the printing device associated with the information processing program accessed in the information processing program access process,
wherein the printing device information includes a setting screen address to the print setting screen.

9. The non-transitory computer readable storage medium according to claim 1,
wherein one information processing program among the plurality of information processing programs is configured to correspond to a first printing device and a second printing device among the plurality of printing devices, and
in the setting screen activation process:
the one information processing program executes a process of displaying a print setting screen of the first printing device on a display unit of the information processing device, in a case where the one information processing program receives a selection operation of the first printing device corresponding to the one information processing program; and
the one information processing program executes a process of displaying a print setting screen of the second printing device on the display unit of the information processing device, in a case where the one information processing program receives a selection operation of the second printing device corresponding to the one information processing program.
